(19) United States
(12) Patent Application Publication
(10) Pub. No.: US 2007/0201931 A1
(43) Pub. Date: Aug. 30, 2007

(54) Front rear switchable keyboard

(76) Inventors: James Harrison Bowen, Elizabeth City, NC (US); James Caluin Fallgatter, Ridgecrest, CA (US)

Correspondence Address: JAMES H. BOWEN, 110 CORPORATE DRIVE, ELIZABETH CITY, NC, 27909, US

(21) Appl. No.: 11/363,423

(22) Filed: Feb. 28, 2006

(51) Int. Cl. B41J 5/00

(52) U.S. Cl. 400/486

(57) ABSTRACT

A keyboard with a more standard qwerty key pattern on a top surface where an operators hands approach the keyboard from a front side for use as a standard keyboard for front data input and then the same keyboard electronically switches to two separate more 90 degree key patterns on the same top surface where an operators hands approach the keyboard from the two ends of the keyboard and then place the keyboard on the rear of a PDA or other host for rear key input. To also incorporate a cradle or attachment means for PDA's and the like on the opposite side from the keyboard. To also be a PDA or held computer with fixed rear keyboard, and to allow more ergonomic key input.

### BACKGROUND OF THE INVENTION

1. Field of the Invention

The present invention generally relates to keyboards related to and for personal data assistants (PDA's), cellular communicating devices, portable hand held games and computers, personal computers, and notebook computers.

2. Description of the Prior Art

PDA's, other small cellular communicating devices and games generally have small keys and key patterns, or thumb key patterns making typing on them limited to short duration's of time and slower input speeds. So to make the keys larger for ease of typing plus keeping these devices small, keyboards are being made large and small to plug into these communicating devices.

U.S. Pat. No. 5,644,338, Bowen, shows split keyboards on notebook computers and the like hinged on the side.

U.S. Pat. No. 6,297,752, Ni, shows split keyboards hinged on the corner to a center device and rotated to the rear of a device.

U.S. Pat. No. 5,410,333, Conway, shows a split keyboard connected at a mid point and hinged to move to different angles with keys on the rear surface.

U.S. Pat. Nos. 5,378,069, 5,577,848, 5,605,406, 5,707,160, 5,785,439, Bowen show a keyboard that detects an operators finger optically.

### SUMMARY OF THE INVENTION

It is therefor the primary objective of this invention to have a keyboard with a more standard qwerty key pattern on a top surface where an operators hands approach the keyboard from a front side for use as a standard keyboard for front data input and then the same keyboard electronically switches to two substantially opposing key patterns on the same top surface where an operators hands approach the keyboard from the two ends of the keyboard and then place the keyboard on the rear of a PDA or other host for rear key input. Where substantially ninety degrees meaning about ninety degrees while allowing for substantially to be within an operators comfort zone whether it be more or less that ninety degrees, in some cases an operators comfort zone could be closer to forty five degrees for the operators hands to use the keyboard from either the front or the rear.

It is a further objective of this invention is to have a display to display the rear key patterns for training purposes when typing on the rear surface, and then the same display to enable full PDA or the like operation with front and rear keyboard input.

It is a further objective of this invention to have a keyboard where the key pattern is grouped in two or more individual key patterns where two of the key patterns are opposed and rotated substantially 90 degrees to each other.

It is a further objective of this invention is to incorporate a cradle or attachment means for PDA's and the like on the opposite side from the keyboard.

It is a further objective of this invention is when being used with some devices the device control keys may or may not be in the qwerty pattern or to the sides of the qwerty pattern and may or may not change when the key pattern electronically switches for rear key input.

It is a further objective of this invention is when the keyboard or PDA and keyboard are not in a confined area to have a split and separated more ergonomic keyboard keeping the operators wrists straight.

### BRIEF DESCRIPTION OF THE DRAWINGS

The foregoing and other objects, aspects and advantages will be better understood from the following detailed description of the invention with reference to the drawings, in which:

FIG. 1 is view A-A standard of the keyboard and primary key pattern in FIG. 2 showing a qwerty key pattern in a horizontal orientation to be used when not rigidly attached to a PDA or the like in accordance with the teachings of this invention;

FIG. 1A is view A-A rotated of the keyboard in FIG. 2 showing a qwerty key pattern in two substantially opposing directions to be either used when rigidly attached to a PDA or the like with a key pattern only electronically rotated, or the primary key pattern in a rear data entry keyboard in accordance with the teachings of this invention;

FIG. 2 is a side view of a keyboard showing the direction of view of view A-A and view B-B in accordance with the teachings of this invention;

FIG. 3 is view B-B of the keyboard in FIG. 2 showing a display with the pattern of keys in FIG. 1A displayed on the display for rear typing training purposes in accordance with the teachings of this invention;

FIG. 4 is view C-C of the keyboard in FIG. 5 showing a qwerty key pattern in a horizontal orientation on the opposite side of a cradle for PDA's and the like;

FIG. 5 is a side view of a keyboard showing the direction of view of view C-C and view D-D in accordance with the teachings of this invention;

FIG. 6 is view D-D of the keyboard in FIG. 5 showing a view of the cradle in accordance with the teachings of this invention;

FIG. 7 is a view of a PDA or like device in a mid point sliding into the cradle of FIG. 5 in accordance with the teachings of this invention;

FIG. 8 is a side view of the keyboard in FIG. 2 with an auxiliary key guard in accordance with the teachings of this invention;

FIG. 9 is a view of a PDA or like device in a mid point being placed into a similar cradle as in FIG. 5 in accordance with the teachings of this invention;

FIG. 9A is a side view of the cradle in FIG. 9 further showing connection contacts with a PDA or like device at mid point being placed into the cradle in accordance with the teachings of this invention;

FIG. 10 shows a PDA attached to the rear side of the keyboard in accordance with the teachings of this invention;

FIG. 10A shows a side view of FIG. 10 with the PDA attached with velcro to the keyboard in accordance with the teachings of this invention;

FIG. 11 is a view showing a split keyboard and center section with linkage there between allowing the split keyboards to move from a front more ergonomic operable position and a rear operable position with a PDA attached to the front in accordance with the teachings of this invention;

FIG. 12 is a view showing the direction of view of view E-E and view F-F and further showing a split keyboard and center section with linkage there between allowing the split keyboards to move through a closed position and two operable positions in accordance with the teachings of this invention;

FIG. 13 is view E-E of FIG. 12 showing the split keyboards the rear operable position in accordance with the teachings of this invention;

FIG. 14 is view F-F of FIG. 12 showing the split keyboards the front operable position and closed position in accordance with the teachings of this invention;

FIG. 15 shows split keyboards attached to a center section in a front more ergonomic operable position and a rear operable position with a PDA attached to the front of the center section in accordance with the teachings of this invention;

FIG. 16 showing the direction of view of view G-G and view H-H and further shows split keyboards attached to a center section in a front and rear operable position in accordance with the teachings of this invention;

FIG. 17 is view G-G of FIG. 16 showing the split keyboards the rear operable position in accordance with the teachings of this invention;

FIG. 18 is view H-H of FIG. 16 showing the split keyboards the front operable position in accordance with the teachings of this invention;

FIG. 19 is view I-I standard qwerty of FIG. 20 showing a staggered key pattern of a keyboard with optical finger detection in accordance with the teachings of this invention;

FIG. 20 is a view showing the direction of view of view I-I and view J-J and further showing a section view of the optical finger detection in accordance with the teachings of this invention;

FIG. 21 is view I-I rotated qwerty of FIG. 20 showing a staggered key pattern when the keyboard is on the rear of a of a PDA with a split and rotated key pattern on a keyboard with optical finger detection in accordance with the teachings of this invention;

FIG. 22 is view J-J of the keyboard in FIG. 20 showing a display and keys in accordance with the teachings of this invention;

FIG. 22A is a view of a keyboard showing a touch sensitive surface with a qwerty key pattern to be used for front data entry in accordance with the teachings of this invention;

FIG. 22B is a view of the keyboard in FIG. 22A showing a touch sensitive surface with a split and rotated qwerty key pattern in two substantially opposing directions to be used for rear data entry in accordance with the teachings of this invention;

FIG. 23 is a schematic illustrating the microprocessor section of the keyboard in accordance with the teachings of this invention;

FIG. 24 is a flow chart showing the program in the microprocessor for controlling the front rear keyboard in accordance with the teachings of this invention;

FIG. 25 is a view showing an operator facing the front rear keyboard with the keys nearest to the operator for front data entry in accordance with the teachings of this invention; and

FIG. 26 is a view showing an operator with the same front rear keyboard in FIG. 25 with the keys facing away from the operator for rear data entry and a PDA or like host nearest to the operator attached to the front rear keyboard in accordance with the teachings of this invention.

### DETAILED DESCRIPTION OF THE INVENTION

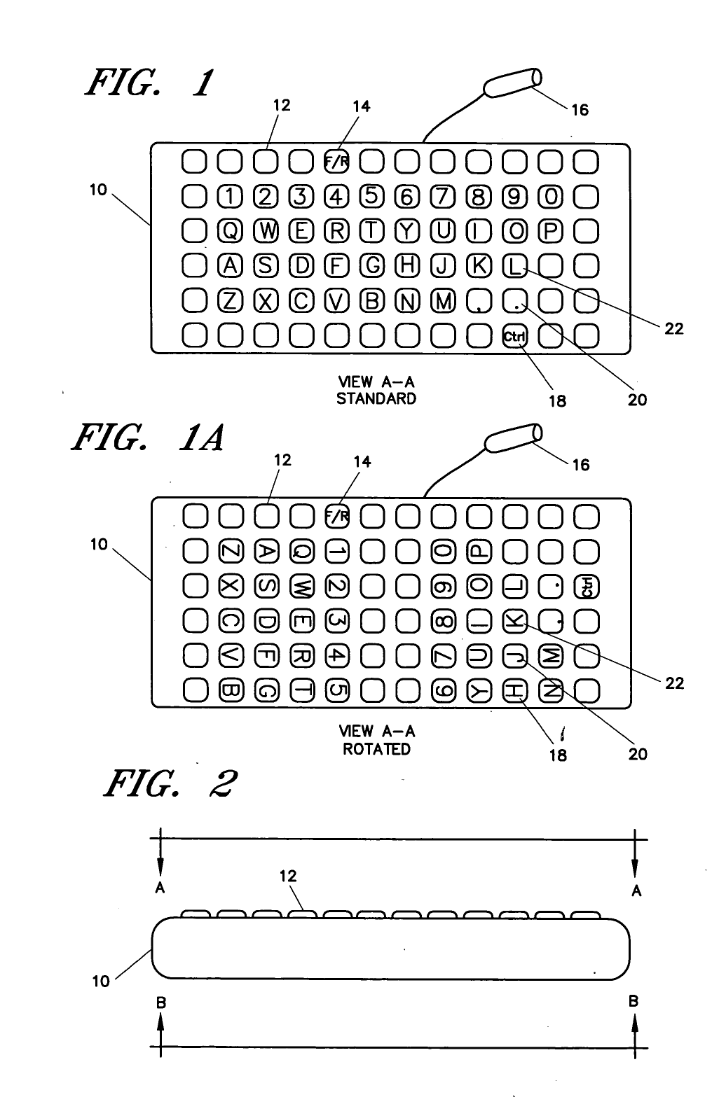

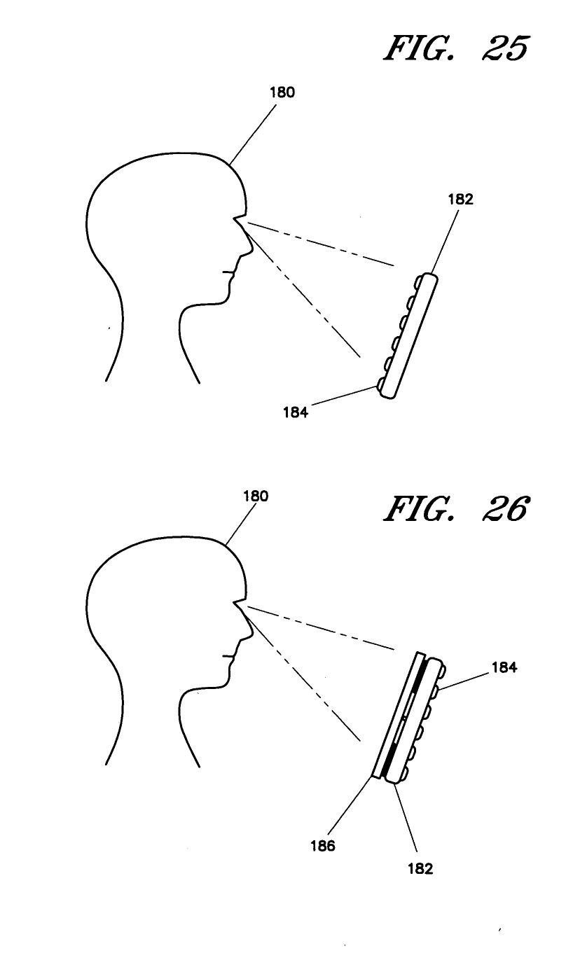

Referring now to the drawings, in which the same reference numeral indicates the same element in the various figures, FIG. 1 is view A-A STANDARD of the top surface of front rear keyboard 10 of FIG. 2 showing the primary qwerty key pattern with a plurality of keys in a horizontal orientation to be used when not rigidly attached or mounted to the rear of a PDA or the like when facing the operator as shown in FIG. 25, or rigidly attached to the rear of a PDA and with a key pattern only electronically rotated or aligned in a second substantially opposing orientation optimized for the left and right hand for rear typing as shown in FIG. 1A and shown in FIG. 26 facing away from an operator or in an opposite direction. This is advantageous because PDA's and similar devices are continuing to be reduced in size and one drawback to get to a even smaller size is if the standard PDA keyboard remains on the front of the PDA the keys must be large enough to operate, by putting the keyboard on the rear surface then that opens up more area than a PDA presently has. Key 12 is one of a plurality of keys in the depicted matrix of keys making up a keyboard. These keys constituting a key position can be full travel, membrane, carbon deposited, optical, touch sensitive resistive, touch sensitive capacitive or other types of key positions. It should also be appreciated to those skilled in the art that a matrix of pins with a switch detect means can be used such as in a pin keyboard where the physical pin switch does not rotate, just the pin switch assignment. Key 12 or other keys can be a key in a more standard qwerty pattern or a control key specific to a specific particular host or particular to a class of hosts and may or may not be electronically rotated depending on the use of the key. The qwerty key pattern could also have control keys between the more standard qwerty key patterns optimized for left and right hand data input that do not electronically rotate when the qwerty keys do. As shown in a more standard qwerty pattern front rear key 14 when touched toggles between a front operable keyboard using a qwerty key pattern and a rear operable keyboard using the electronically rotated pattern. This allows for one keyboard to be connected to many different devices either standalone or mounted to the rear of the host device. Those skilled in the art can appreciate that although the qwerty pattern is referenced throughout the pattern could be a Dvorak or other pattern either staggered or non staggered key position suited to other applications or personal preference. There is new interest that non-staggered keyboard patterns are more efficient and offer less stress to the hands and arms and the key pattern of FIG. 1 could be one.

When front rear keyboard 10 is used free standing and connected to a host via more standard flexible PS2, USB or other interfacing type connector 16 it can have a key pattern like or similar to the qwerty pattern shown.

When front rear keyboard 10 is mounted to the rear of a PDA, cellular communicating device or similar device the operator is unable to see the keys, only their experience and memory tells the operator where keys are so by allowing the operator to use their present skills the same relationship to keys on the qwerty pattern is retained in the rear pattern. So by electronically splitting the keys where they are optimized for left and right hand typing then rotating them substantially 90 degrees in the same plane the relationship for each hand allows muscle memory to be maintained. This is shown by control indicia on key 18 which in a qwerty pattern is the control key, when on the rear it becomes the H key which would be touched by the index finger of the right hand the same as if in a qwerty pattern in the standalone pattern. Further the period key 20 would become the J key, and L key 22 becomes the K key. It should be obvious to those skilled in the art that different key optimizations and dual marked keys or multiple indicia on the keys could be used to possibly better fit some applications.

FIG. 1A shows a pattern of keys that can be the primary pattern in a fixed pattern keyboard where the output from the keys does not change showing a rectangular qwerty key pattern in two substantially opposing directions. Depending on customer preference the rectangular qwerty pattern could be a staggered qwerty as shown in FIG. 21. Or it can be the view A-A ROTATED of the keyboard in FIG. 2 to be used when rigidly attached to a PDA or the like with a key pattern only electronically rotated and facing away or in an opposite direction from an operator as shown in FIG. 26. When only electronically rotated this plurality of keys are the same as in FIG. 1 except that the key assignments have been electronically changed. The indicia as shown is only for clarity to show the electronically rotated key pattern unless the keys are dual marked wherein both the more standard qwerty pattern as shown in FIG. 1 and the rotated key pattern are on each key.

If the key pattern in FIG. 1 is to be a primary key pattern it can then be used for data entry and may not necessarily be rotated for rear data entry. In contrast when the key pattern in FIG. 1A is the primary key it may not necessarily be rotated for front data entry, and can be for only rear data entry.

FIG. 2 is a top view of front rear keyboard 10 with key 12 being only one of a plurality of keys. It also shows the direction of view A-A and view B-B.

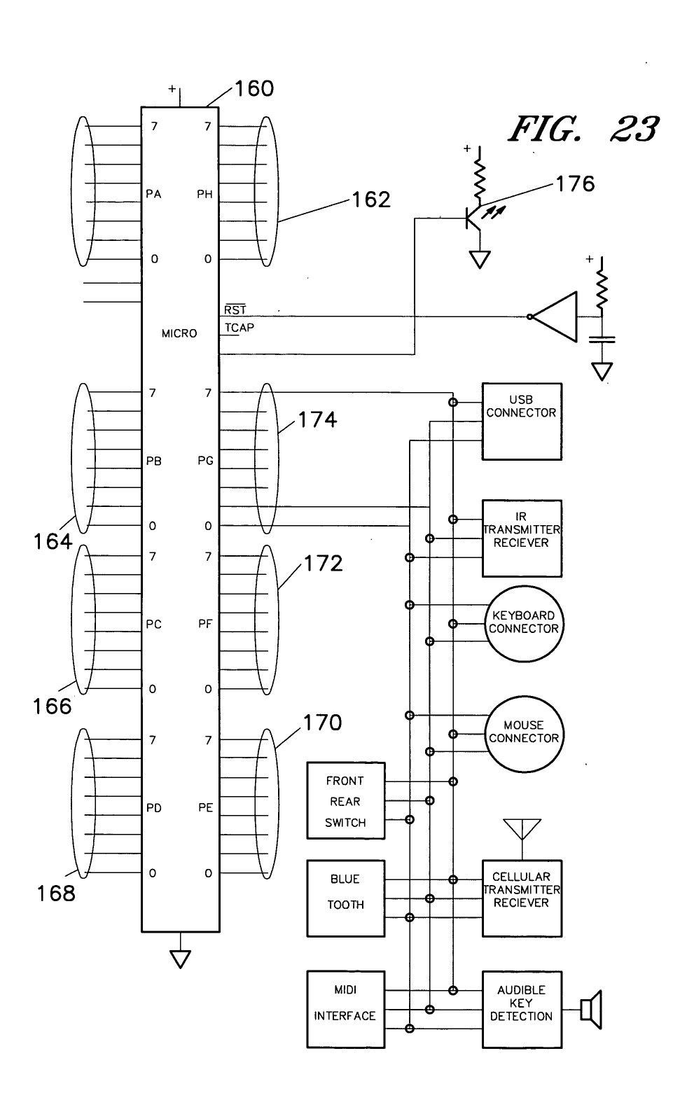

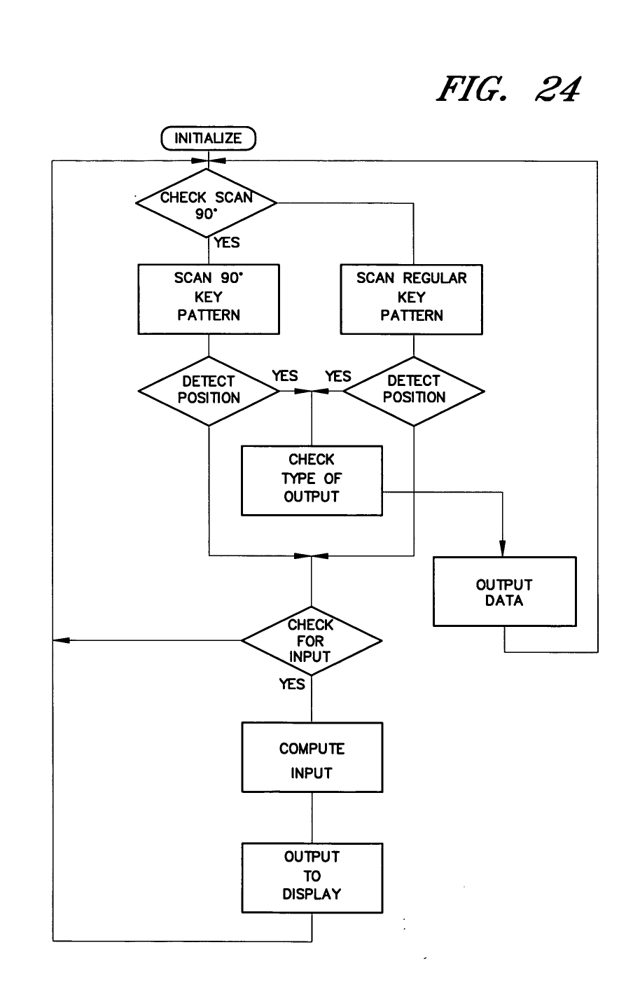

FIG. 3 shows view B-B which is opposite view A-A. When front rear keyboard 10 needs more inputs one of such inputs could be device control key 30. Display 32 shows a rotated key pattern that is used for training purposes and displays on the display an image of the keys and their position as they appear on the opposite side of front rear keyboard 10, similar to looking through a transparent keyboard. Display 32 can also be used for hi-lighting the key or keys an operator is touching to speed any learning-curve needed to increase typing skills. Similarly if the application needs to have a display function as in a full PDA or hand held computer then display 32 can be used with the fixed key pattern as shown in FIG. 1A. Even though front rear keyboard 10 can act as a PDA or like device it can still be connected to another PDA for use if the other PDA has more features, this is advantageous in a world where there are always new devices entering the market to allow front rear keyboard 10 to be able to enhance all the features of new devices by allowing easier key input. Keyboard front rear photo detector 34 can detect the presence of a PDA or other like device when a key position as in FIG. 1 front rear key 14 is not used, and switch front rear keyboard 10 from a qwerty key pattern for front data entry to a split rotated rear key pattern optimized for left and right hand data entry. The blue tooth communication means in FIG. 23 can be used to communicate to and from front rear keyboard 10 or front rear keyboard and cradle 36 of FIG. 5 and a host without any physical connection to a host. Those skilled in the art would appreciate the other detection means or detectors like hall effect sensors, blue tooth communications or the like and that the detection could be the results of a switch closure. Most interfacing type protocols use bi-directional communications and when being connected through connector 16 or connectors like connections 38 of FIG. 5 can also switch the key pattern from a front to rear pattern though that communications link, such detection means can include detection through such communications.

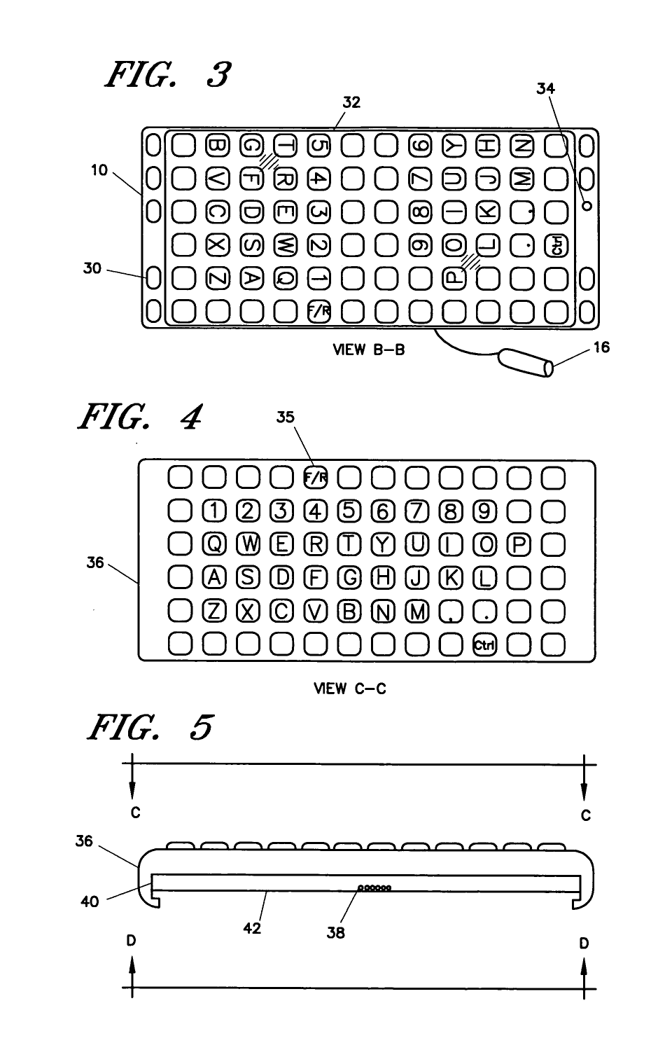

FIG. 4 shows view C-C of FIG. 5 of the slide in front rear keyboard and cradle 36 and an array of keys with the same function as in FIG. 1.

FIG. 5 is a top view showing the direction of view of view C-C and view D-D of slide in front rear keyboard and cradle 36 with slide 40 where a PDA or other like device is slidedibly received down to lower housing stop 42 to be retained and with corresponding electrical connections 38 to connect front rear keyboard and cradle 36 to a PDA or like device.

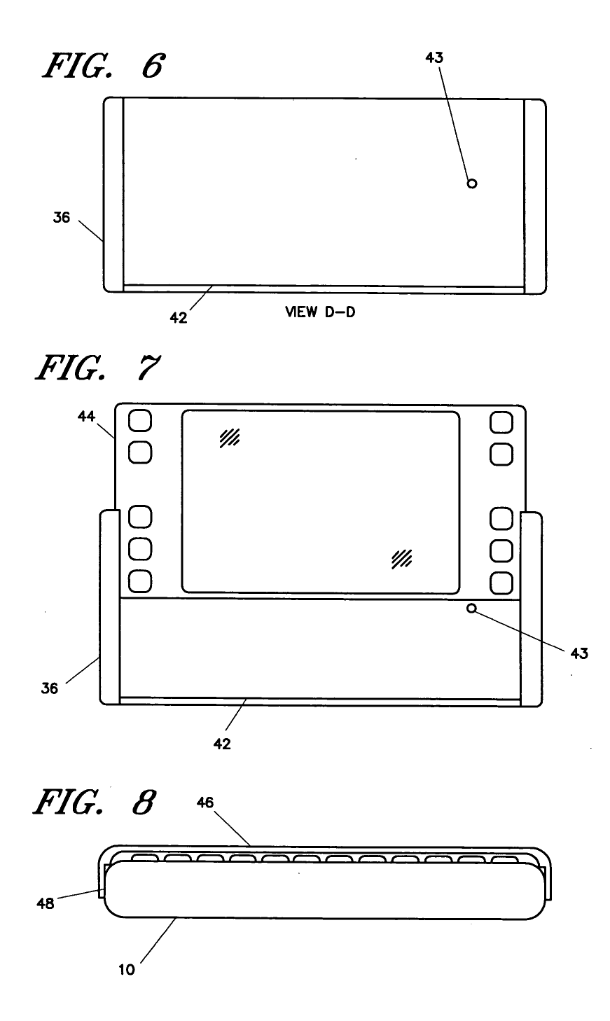

FIG. 6 shows view D-D which is opposite view C-C, and further shows lower housing stop 42. Keyboard front rear detector 43 can detect the presence of a PDA or other like device if and when a key position as in FIG. 4 front rear key 35 is not used, and switch front rear keyboard 10 from a qwerty key pattern for front data entry to a split rotated rear key pattern optimized for left and right hand data entry.

FIG. 7 shows PDA 44 at a mid point sliding into slide in keyboard cradle housing 36 toward lower housing stop 42 just prior to covering front rear detector 43 resulting in switching key from a front key pattern to a rear key pattern.

FIG. 8 shows front rear keyboard 10 as in FIG. 2 with optional key guard 46 snapped there between by snap 48. This is advantageous if front rear keyboard 10 is left on when connected to a cellular device to stop inadvertent key presses. If the key tops on front rear keyboard 10 are sub surface then key guard 46 would be less effective, but when keys 12 of FIG. 1 are above surface in a position as full travel keys for touch typing then key guard in most effective. One key could be sub surface to enable or disable keys 12 but without the key guard the full travel keys could be damaged although not giving inputs.

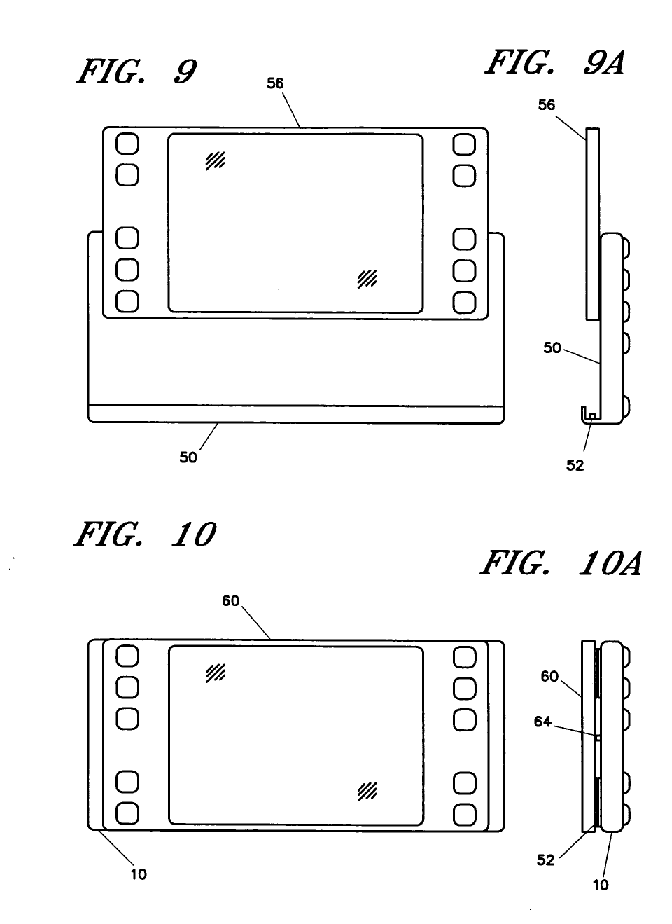

FIG. 9 shows PDA 56 at a mid point being placed into in keyboard cradle housing 50 toward lower connections 52 to electrically connect PDA 56 to cradle housing 50,. In this configuration of cradle the connection can be either in the position of lower connection 52 or in the rear of the of PDA 56 depending on the PDA used.

FIG. 9A shows PDA 56 being placed into cradle 50 with connectors 52 to power and input output signals for bilateral control of cradle 50 and PDA 56. Connectors 52 can also be used for detecting the presence of PDA 56 to switch from a front key pattern to a rear key pattern when and if other detection means are not used.

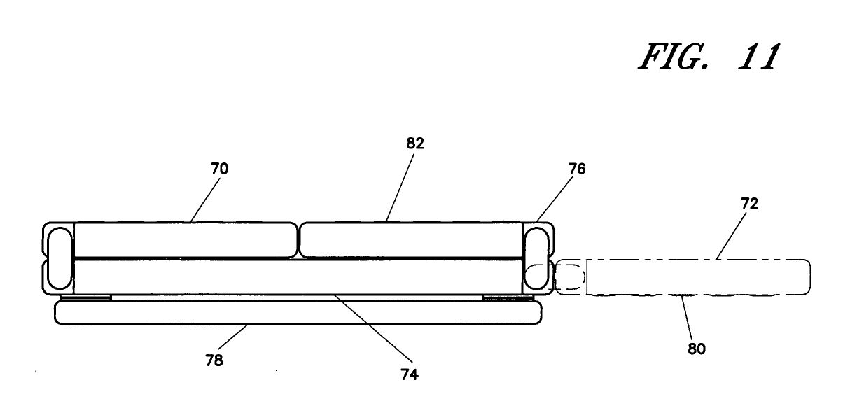

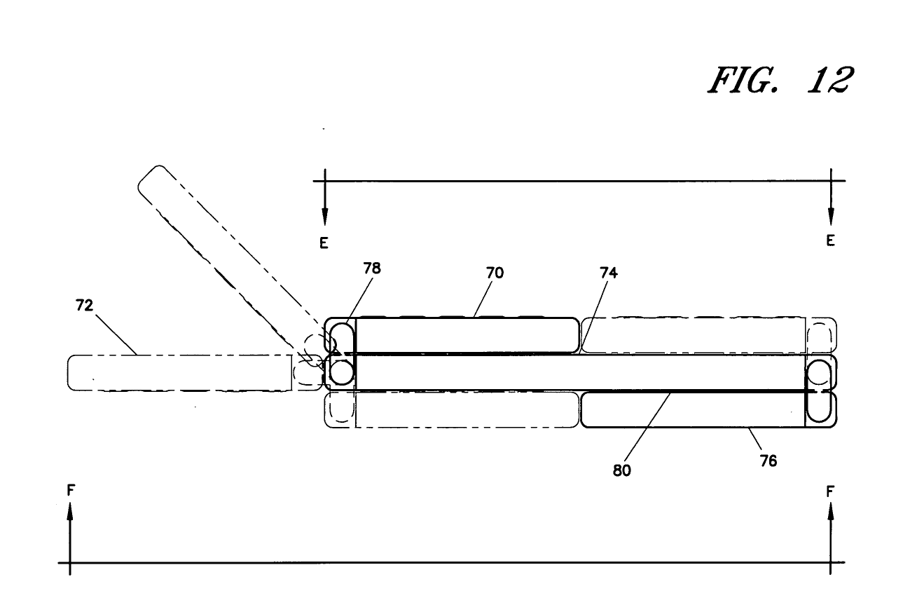

FIG. 10 shows PDA 60 on the rear of front rear keyboard 10.

FIG. 10A shows a side view of FIG. 10 with PDA 60 connected to front rear keyboard 10 with a velcro type material. This is just one of connection means that could be used. When front rear keyboard 10 is designed for a specific PDA then snaps, slides and the like can be made into front rear keyboard 10 to make the connection both mechanical and with electrical connectors 52.

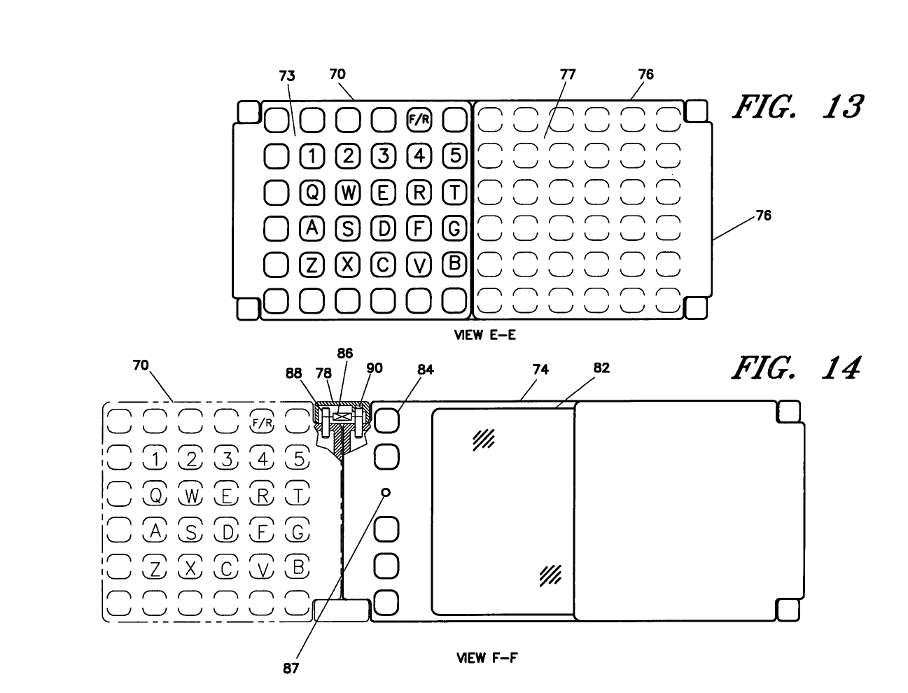

FIG. 11 shows split and rotated left keyboard 70 and split and rotated right keyboard 76, with keys 82, both of which are connected to center section 74 with PDA 78 attached to the opposite side. As with front rear keyboard 10 of FIG. 2 the key pattern is electronically rotated to optimize typing with the left and right hand when PDA 78 is facing the operator and the operator is typing on the rear keys 82 holding PDA 78 and left and right rotated keyboards 70 and 76 in the palms of the operators hand. When right keyboard 76 is not rotated and is in the more ergonomic position 72 keeping the operators wrists more straight the operator can see keys 80 and input data while looking at PDA 78. When the keyboard or PDA and keyboard are not in a confined area this split and separated more ergonomic keyboard is advantageous to relieve stress in the operators wrists while still using a small PDA. When left and right rotated keyboards 70 and 76 are rotated into position the electronics detect the position and electronically rotates the key pattern.

FIG. 12 shows a view of FIG. 11 with the PDA removed allowing left and right rotated keyboards 70 and 76 to be position in a closed position protecting keys 80. FIG. 12 further shows the direction of view of view E-E and view F-F. Left keyboard link 78 connects and holds left rotated keyboard 70 to center section 74.

FIG. 13 shows left rotated keyboard 70 with keys on first top surface 73 and right rotated keyboard 76 with a second top surface 77 with the qwerty key pattern that can be used when plugged into a PC, PDA or like device with the operator looking at the keys when inputting data. It further shows left rotated keyboard 70 with the qwerty key pattern that is not physically rotated, because when attached to the rear of a PDA or like device the operator cannot see the keys while typing the key pattern is only electronically rotated to optimize rear typing with the operators right and left hand.

FIG. 14 is view F-F of FIG. 12 and shows left rotated keyboard 70 in phantom where it would be placed for typing so the operator can see the keys if desired. Center section 74 can have a display 82 and further control keys 84 to operate as a PDA or other like device. Even though center section 74 can act as a PDA or like device it can still be connected to another PDA for use if the other PDA has more features, this is advantageous in a fast moving market where there are always the faster and easier key input provided by a front rear rotating keyboard to be able to enhance all the features of new devices by allowing easier key input. Left keyboard link 78 is held in position by center pin 90 which is spring loaded with spring 86 to keyboard pin 88 within left keyboard link 78. Spring 86 always maintains contact and alignment between center section 74 and left rotated keyboard 70. If front rear detector 87 is present it is to detect the presence of a PDA or like device and switch from a front key pattern to a rear key pattern. When left keyboard 70 is in a closed position front rear detector 87 is also covered but is turned off, or in the case when other detection means are used front rear detector 87 is not there.

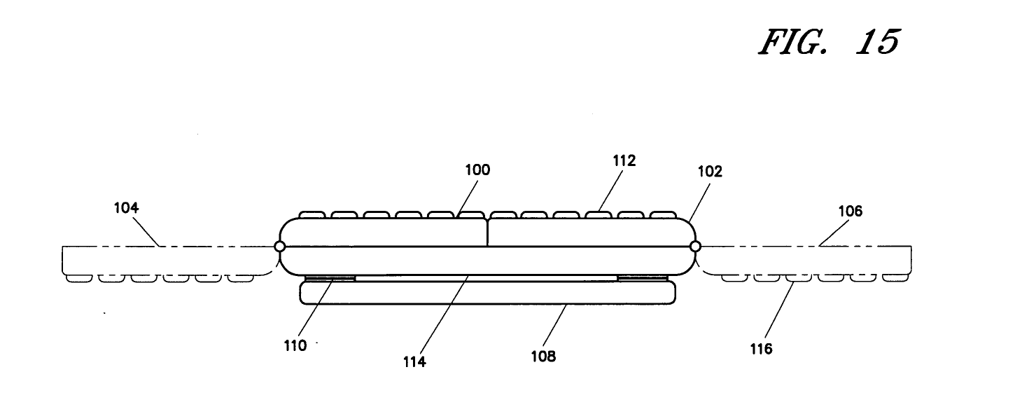

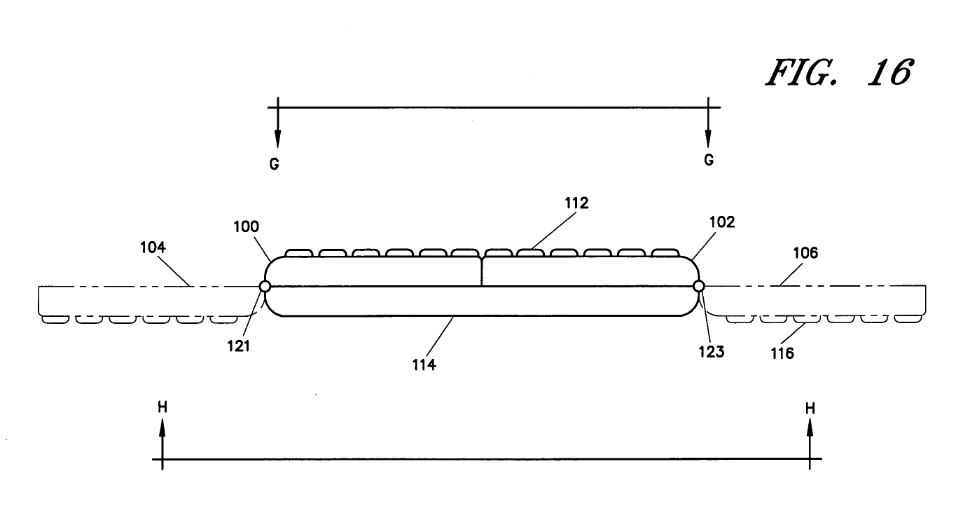

FIG. 15 shows split and rotated left keyboard 100 and split and rotated right keyboard 102, with keys 112, both of which are connected to center section 114 with PDA 108 attached to the opposite side. As with front rear keyboard 10 of FIG. 2 the key pattern is electronically rotated to optimize typing with the left and right hand when PDA 108 is attached and facing the operator and the operator is typing on the rear keys 112 holding PDA 108 and left and right rotated keyboards 100 and 102 in the palms of the operators hands. When right keyboard 102 is not rotated and is in the more ergonomic position 106 keeping the operators wrists more straight the operator can see keys 116 and input data while looking at PDA 108. When left and right rotated keyboards 100 and 102 are rotated into a rear position the qwerty pattern remains until the electronics detects front rear detector 120 of FIG. 18 showing that PDA 108 is attached and electronically rotates the key pattern.

FIG. 16 shows a view of FIG. 15 with the PDA removed allowing left and right rotated keyboards 100 and 102 to be position in an open position 104 and 106 to be plugged into any PC, PDA or like device for data entry, or to download programs, music, or other data from a PC, PDA or like device that an operator can use when used with another device. FIG. 16 further shows the direction of view of view G-G and view H-H. Left and right pivots 121 and 123 connect and allow left rotated keyboard 100 and right rotated keyboard 102 to rotate from center section 114 and to be position at different angles from the shown front position of 104 and 106 to the rear position of left and right rotated keyboards 100 and 102.

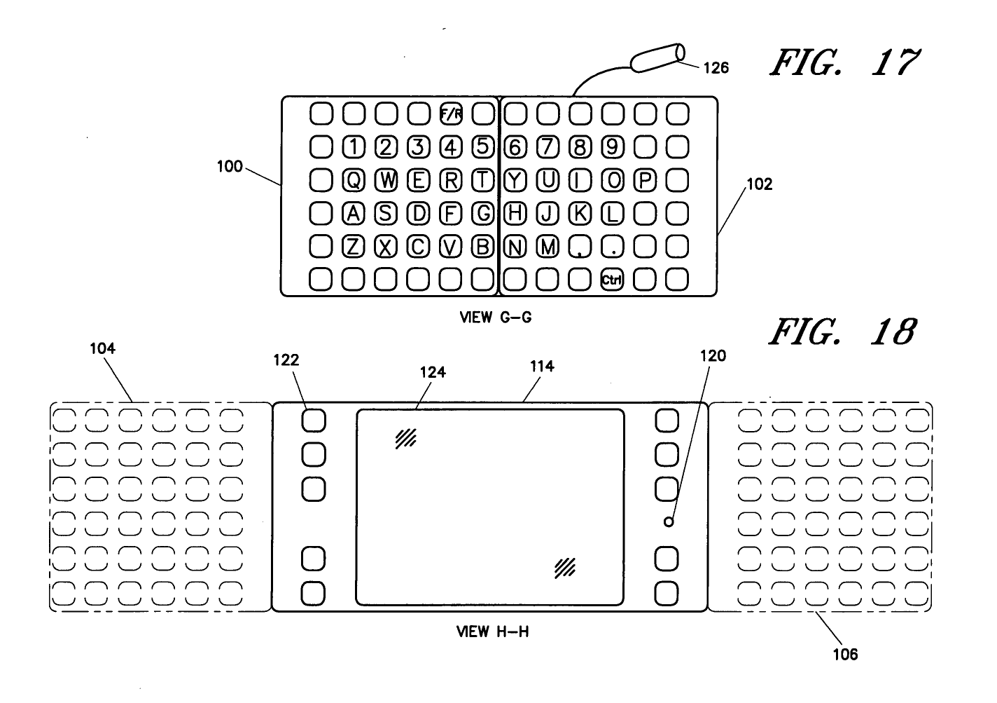

FIG. 17 is view G-G of FIG. 16 and shows left rotated keyboard 100 and right rotated keyboard 102 with the qwerty key pattern that can be used when plugged into a PC, PDA or like device with the operator looking at the keys when inputting data via connector 126 or other connection means. It further shows that the qwerty pattern is not physically rotated, because when attached to the rear of a PDA or like device the operator cannot see the keys while typing the key pattern is only electronically rotated to optimize rear typing with the operators right and left hand.

FIG. 18 is view H-H of FIG. 16 and shows left rotated keyboard 100 in phantom at position 104 where it would be placed for typing so the operator can see the keys if desired. Center section 114 can have a display 124 and further control keys 122 to operate as a PDA or other like device. Even though center section 114 can act as a PDA or like device it can still be connected to another PDA for use if the other PDA has more features, this is advantageous in the world of always a new device on the market to allow the front rear rotating keyboard to be able to enhance all the features of new devices by allowing easier key input. If front rear detector 120 is present it is to detect the presence of a PDA or like device and switch from a front key pattern to a rear key pattern.

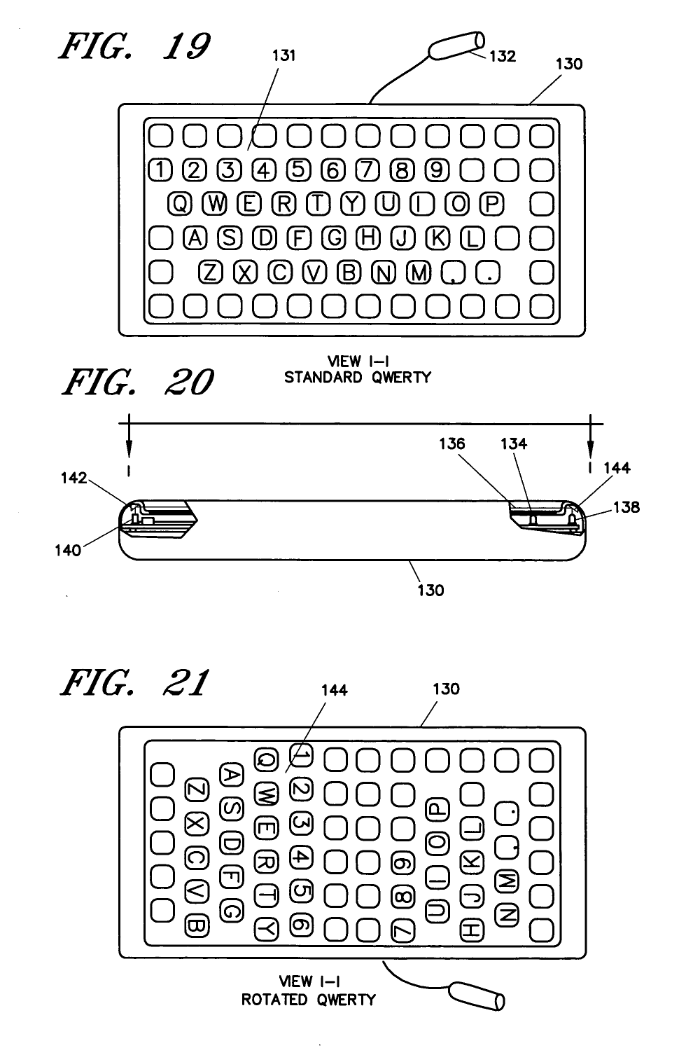

FIG. 19 is view I-I of FIG. 20 and shows a front rear keyboard 130 that detects the operators finger with optics, and further shows a staggered qwerty key pattern 131 of key positions. By detecting an operators finger with optics the location of key positions can be electronically changed or altered to fit different particular applications. When front rear keyboard 130 is connected to or transmitting with a PC, PDA or other device via connector 132 and the operator can look at the key positions, a staggered qwerty or other variations can be programmed into front rear keyboard 130.

FIG. 20 shows front rear keyboard 130 with emitter 138 in section reflecting off emitter mirror 144 with light beam 136 in recess 134 reflecting off of detector mirror 142 in section to detector 140. When an operators finger blocks light beam 136 a finger is detected by the electronics scanning for the operators finger. Staggered qwerty key pattern 131 is disposed in recess 134 and can be used for front data entry.

FIG. 21 shows an alternate staggered key pattern 144 that is two separate rotated key patterns that are rotated in the same plane and is only representative of what the electronics is scanning when a second scan is made for rear data input when front rear keyboard 130 is attached to the rear or transmitting with a host like a PDA or other device. If the operator would turn over front rear keyboard 130 they would see the staggered qwerty key pattern 131 or other key pattern required for other data entry of FIG. 19. Using electronic finger scanning the staggered key pattern can be electronically maintained on the rear so an operator can type on the rear with the same relative key positions for the left and right hand as used on the front qwerty key pattern. Even key patterns that are enhanced for the length of different fingers can be accommodated wherein keys for a little finger can be closer to a palm than keys for example a middle finger.

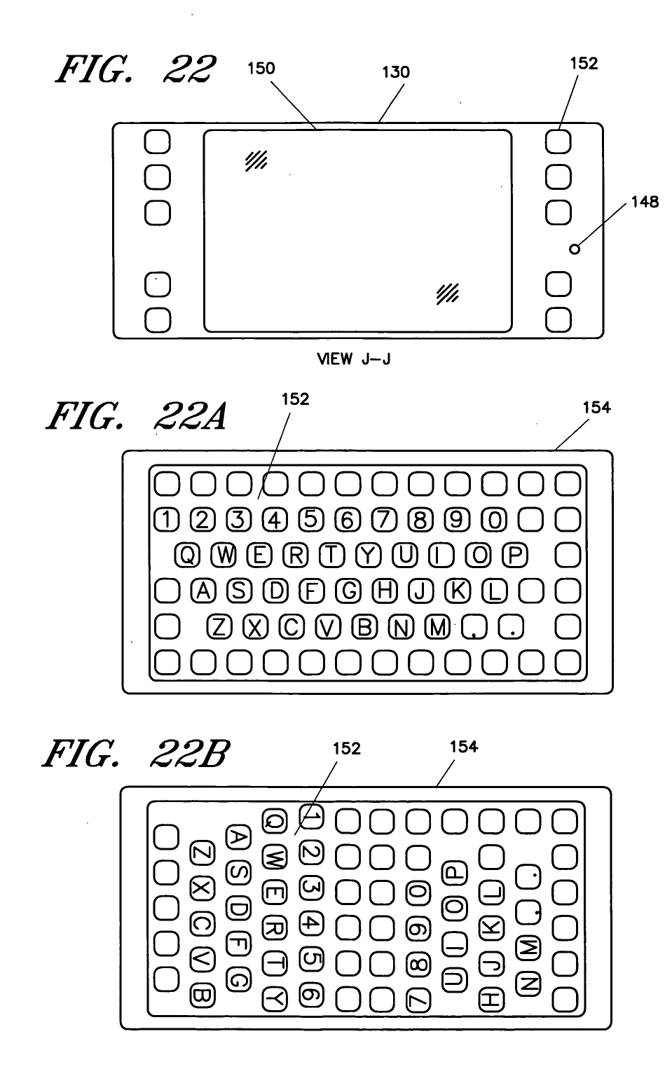

FIG. 22 shows view J-J which is opposite view I-I. When front rear keyboard 130 needs more inputs one of such inputs could be device control key 152. Similarly if the application needs to have a display function as in a PDA then display 150 can be used. Even though front rear keyboard 130 can act as a PDA or like device it can still be connected to another PDA for use if the other PDA has more features, this is advantageous in the world of always a new device on the market to allow front rear keyboard 130 to be able to enhance all the features of new devices by allowing easier key input. Front rear detector 148 can sense the presence of a PDA or other device and switch the scanning pattern from a pattern for front data entry to an alternate rear staggered key pattern 144 pattern as shown in FIG. 21.

FIG. 22A is a view of front rear keyboard 154 showing touch sensitive surface 152 over a display displaying an image of a plurality of key positions with a more standard qwerty key pattern to be used for front data entry. Whereas the detection locations of the keys and the key pattern can change from a front key pattern to a rear key pattern as in FIG. 22B.

FIG. 22B is a view of the keyboard in FIG. 22A showing touch sensitive surface 152 showing when the key pattern has been changed to a rear key pattern with a split and rotated qwerty key pattern and detection thereof in two substantially opposing directions to be used for rear data entry. This is advantageous because by displaying the image of the keys as in FIG. 22A to be used for front data entry the actual intra position of the optimized key pattern for left and right hand data entry of FIG. 22A can be maintained even when displaying the keys in the rotated optimized key pattern for left and right hand rear data entry of FIG. 22B.

FIG. 23 shows a electronic schematic of front rear keyboards as shown in the within FIG's of this embodiment for but not limited to detecting key positions, the presence of and communicating with PDA's or other devices. Microprocessor 160 is programmed to initiate sequences to control ports 164, 166, 168, 170, 172, and 174 to scan for key or finger positions; to interconnect through port 162 to a PDA in a cradle; to detect the presence of another device through detector 176; and to input output via USB, IR transmission, keyboard, mouse, cellular transmissions, blue tooth transmissions and MIDI to a host attached to the keyboard or to a distant host or sub station for full network type communication. And output audible finger or key detection.

FIG. 24 is a flow chart showing the program in the microprocessor for controlling the front rear keyboard which starts at INITIALIZE where the processor initializes registers and other section of the processor. At CHECK SCAN 90 Degrees a test is made to see if the keyboard is set to do a more normal qwerty scan or a split and rotated scan, if a more regular scan then at SCAN REGULAR KEY PATTERN the key positions are scanned for detection of a key or finger then at DETECT POSITION a test is made to see is a detection has been made, if it has detected a key then a check is made at CHECK TYPE OF OUTPUT and the appropriate output is made at OUTPUT DATA and returned to start the scan again. If at DETECT REGULAR POSITION no key is detected it continues to CHECK FOR INPUT. If at CHECK SCAN 90 Degrees the 90 degree is selected then a scan is made at SCAN 90 Degree KEY PATTERN is made, if a key or finger is detected at DETECT 90 Degree POSITION then it continues to CHECK TYPE OF OUTPUT. If no key is detected at DETECT 90 Degree POSITION then it continues to CHECK FOR INPUT, if no input is detected then it returns to start a new scan. If an input is detected then it goes to COMPUTE INPUT and sees what is to be done, then at OUTPUT TO DISPLAY the results are either sent to the display or directed internally to change a control setting of the microprocessor, then it returns to start a new scan.

FIG. 25 is a view showing operator 180 facing the front rear keyboard 182 with the keys 184 nearest to operator 180 for front data entry.

FIG. 26 is a view showing operator 180 with the front rear keyboard 182 of FIG. 25 with keys 184 facing away from operator 180 for rear data entry and PDA or like host 186 nearest to the operator attached to front rear keyboard 182.

It should be appreciated to those skilled in the art that although the FIG's. herein show a limited key pattern that more keys is only a matter of reducing the size of the keys and key pitch or increasing the size of the keyboard.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A front rear switchable keyboard, comprising:
a keyboard having at least a first top surface of at least a first housing;
at least a first plurality of key positions disposed on said at least first top surface;
at least one indicia disposed on at least a portion of said at least a first plurality of key positions;
at least a portion of said key positions having at least a first and second output code assignment;
wherein when said top surface is facing in a first direction said at least first output code assignment is assigned to said key positions and is representative of said at least one indicia oriented in a first orientation being in the same direction in respect to each said at least one indicia;
wherein when said top surface is facing in a second direction being substantially opposite said first direction said at least second output code assignment is assigned to said key positions and is aligned in a second orientation being in at least two substantially opposing directions and can be irrespective of said at least one indicia; and
means to communicate said at least first and second output code assignment to a host.

2. The front rear switchable keyboard as claimed in claim 1, further including
a means for switching from said at least a first output code assignment to said at least second output code assignment.

3. The front rear switchable keyboard as claimed in claim 1, further including
a rear surface opposite said at least first top surface.

4. The front rear switchable keyboard as claimed in claim 3, further including
a display disposed on said rear surface; and
whereas said display being used to at least display input and output data to and from at least said plurality of key positions.

5. The front rear switchable keyboard as claimed in claim 4, wherein
said display displays said key positions representative of said at least second output code assignment.

6. The front rear switchable keyboard as claimed in claim 4, further including
at least one key for controlling input to said display.

7. The front rear switchable keyboard as claimed in claim 3, further including
a holding means disposed on said rear surface to hold said host.

8. The front rear switchable keyboard as claimed in claim 1, further including
a communications means for bi-directional communication to said host.

9. The front rear switchable keyboard as claimed in claim 1, further including
at least a second plurality of key positions disposed on a at least a second top surface of at least a second housing; and
means to connect said at least first housing to said at least second housing.

10. A keyboard connected to or connectable to a host, comprising:
at least one housing having a top and a bottom surface;
a plurality of keys positioned on a top surface of said at least one housing, at least a portion of said plurality of keys being indicative of at least two different alphanumeric characters, grammatical characters or function inputs; and
a communication pathway for transmitting data to said host wherein a first of said at least two different alphanumeric characters, grammatical characters or function inputs is transmitted to said host when said top surface of said at least one housing is facing in a first direction and a second of said at least two different alphanumeric characters, grammatical characters or function inputs is transmitted to said host when said top surface of said at least one housing is facing in a second direction substantially opposite said first direction.

11. The keyboard of claim 10 wherein said at least one housing include at least two separate housing members each with a different set of said plurality of keys.

12. The keyboard of claim 10, further including
a display disposed on said bottom surface; and
whereas said display being used to at least display input and output data to and from at least said plurality of key positions.

13. The keyboard of claim 12, further including
at least one key for controlling input to and from said display.

14. The keyboard of claim 10, further including
a holding means disposed on said bottom surface to hold said host.

15. A hand held keyboard, comprising:
a keyboard having a top surface;
a plurality of key positions disposed on said top surface in at least two groups;
two of said at least two groups being at least a split QWERTY left group for a left hand and a split QWERTY right group for a right hand;
said left group rotated clockwise substantially ninety degrees opposing said right group rotated counter clockwise substantially ninety degrees;
said plurality of key positions having an at least first output code assignment; and
means to communicate said at least first output code assignment from said plurality of key positions.

16. The keyboard of claim 15, further including
a rear surface opposite said top surface.

17. The keyboard of claim 16, further including
a display disposed on said rear surface; and
whereas said display being used to at least display input and output data to and from at least said plurality of key positions.

18. The keyboard of claim 17, further including
indicia disposed at least a portion of said plurality of key positions; and
wherein said display displays said plurality of key positions from said top surface and said indicia from said plurality of key positions.

19. The keyboard of claim 17, further including
means for bi-directional communication to and from a host via an antenna.

20. The keyboard of claim 16, further including
a holding means disposed on said rear surface to hold a host.

21. The keyboard of claim 20, further including
a communications means to communicate to said host.
